(19) United States
(12) Patent Application Publication
(10) Pub. No.: US 2015/0332423 A1
(43) Pub. Date: Nov. 19, 2015

(54) Automatic system for enhanced swing-issue voting

(71) Applicant: Robert M. Hager, Northfield, MN (US)

(72) Inventor: Robert M. Hager, Northfield, MN (US)

(21) Appl. No.: 14/692,908

(22) Filed: Apr. 22, 2015

Related U.S. Application Data
(60) Provisional application No. 61/982,853, filed on Apr. 22, 2014.

(51) Int. Cl. G06Q 50/26; G07C 13/00; G06Q 10/10; G06F 17/30

(52) U.S. Cl. CPC G06Q 50/26; G06F 17/30339; G06F 17/30598; G07C 13/00; G06Q 10/10

(57) ABSTRACT

A method of organizing voting members of a district to shift margin of victory between candidates in an election includes providing a server for running a program linked to a database. The program provides a website configured for entry of voting member identifying information and voting member contact information for storage in the database. The website is further configured for entry of a conditional pledge by the voting member for storage in the database. The method further includes receiving the identifying and contact information, receiving the conditional pledge from voting members on the website, and storing the information and the conditional pledges in the database. A calculation is performed to determine whether a first pledge condition has been reached. When the first pledge condition has been reached, the voting members with conditional pledges stored in the data base are informed that the first pledge condition has been reached and to vote according to their pledge.

### FIELD

This patent application generally relates to a system of swing-issue voting. More particularly, it relates to system to overcome the corrupting influence of money in elections. Even more particularly, it relates to system to empower ordinary citizens to counter the vast influence of money in elections and reclaim democratic control of government and restore government of by and for the people.

### BACKGROUND

The decisions in a line of cases including Citizens United opened the floodgates to money in elections, corrupting the electoral system and many elected officials. The decisions also improperly encroached on congressional power. The corrupting influence of money discouraged Congress from using its existing constitutional powers to check and balance the Court. Thus, government of by and for the people was overturned, replaced by corrupted government of by and for the 1%, and the money in elections made ordinary voting ineffective.

The Supreme Court's recent McCutcheon case went even further, legalizing the systemic corruption of political parties. Voting either for individual candidates or for one of the two major parties engaged in the now legalized systemic corruption has been rendered ineffective. For example, an article by Martin Gilens and Benjamin I. Page, “Testing Theories of American Politics: Elites, Interest Groups, and Average Citizens” (2014) analyzes data that shows that “economic elites and organized groups representing business interests have substantial independent impacts on U.S. government policy, while average citizens and mass-based interest groups have little or no independent influence.”

Polls also show that a majority of Americans believe that the political system is broken, corrupted by vast amounts of corporate money. Furthermore, to remove money from elections no constitutional amendment is needed. The existing constitution already includes powers by which either Congress or state legislatures or both can take effective action, as described in the article, “Why a Constitutional Amendment Isn't Needed to Overturn “Citizens United,” by Rob Hager, et al. available at the web site, http://www.counterpunch.org/2012/07/09/why-a-constitutional-amendment-isnt-needed-to-overturn-citizens-united/ and “Montana Citizens United and the Eleventh Amendment,” by Russell Mokhiber, available at the web site http://www.counterpunch.org/2012/06/11/montana-citizens-united-and-the-eleventh-amendment/. Thus, not just support among the population is high but the solution is relatively easy to achieve if Congress was not itself already corrupted by money in elections.

Notwithstanding the majority support for effective action to change the campaign finance system, and notwithstanding the ease of solution using existing constitutional provisions, effective action has not been taken by Congress, by state legislatures, or by state Attorneys General, all of whom have power to take effective action based on already-existing constitutional provisions, including Article I, sections 4 and 5 and the last paragraph clause 18 of section 8; Article III, section 2, second paragraph, last sentence; Article IV, section 4, first clause, Article VI, third paragraph, and the 11^{th} Amendment.

A key problem is that politicians, including members of Congress, are insulated from public opinion by the vast amounts of money unleashed in elections by a line of US Supreme Court rulings that began in 1976, starting with Buckley v. Valeo, and including Citizens United and McCutcheon.

In arguing the McCutcheon election financing case before the US Supreme Court, Solicitor General Donald Verrilli pointed out that the system set in place by the Court does not just corrupt individual politicians. He described how systemic corruption of elections set in place with donations of up to $3.6 million corrupts both major political parties, their party leaders, their candidates, and their office holders. Verrilli said:
The party leaders are often going to be the ones who solicit those contributions, and their authority depends on the party retaining or gaining a majority in the legislature. [Since] every candidate is going to get a slice of the money and every candidate is going to know that this person who wrote the multimillion dollar check has helped not only the candidate, but the whole team . . . that creates a particular sense of indebtedness. . . . every officeholder in the party is likely to be leaned on by the party leadership to deliver legislation to the people who are buttering their bread.
A party's got to get $1.5 billion together to run a congressional campaign, parties and candidates together, and you've got a maximum of $3.6 million, that is about 450 people you need to round up. [Without] the aggregate limits . . . there is a very real risk that . . . the government will be run of, by, and for those [few political investors].

Using the term “profound” in the sense of “systemic” the Solicitor General concluded: “the risk of corruption is real. And we think it's in fact profound when you are talking about . . . tak[ing] the lid off on aggregate contributions.” See Hager, “McCutcheon: Plutocracy is Corruption” http://www.opednews.com/articles/McCutcheon-Plutocracy-is-by-Rob-Hager-Corruption^{—}Plutocracy-131019-252.html

As Justice Breyer explained in his dissenting opinion in the same case, systemic corruption is profound in the sense that it operates at a fundamental level, interfering with the foundations of democracy, subverting the political process, reducing political participation, and preventing ordinary electoral techniques, including participation in voting for parties and candidates, from working to implement the will of the majority.

The constitution provides Congress with several different tools to check and balance the court, particularly when the court encroaches on a power exclusively given to Congress. Congress failed to use any these tools to check and balance the Supreme Court to prevent and reverse its encroachment despite the fact that maintaining elections free of corruption are fundamental to democracy and the continued existence of constitutional government.

What is needed is a way for the voters to require Congress to use the existing powers provided to Congress under the constitution to check and balance the overreaching by the Supreme Court and to use the existing powers provided to Congress under the Constitution to remove money from elections, despite the corruption of Congress by money in elections.

This patent application provides a way for the voters to do just that.

### SUMMARY

One aspect of the present patent application is a method of organizing voting members of a district to shift margin of victory between candidates in an election. The method includes providing a server for running a program linked to a database. The program provides a website configured for entry of voting member identifying information and voting member contact information for storage in the database. The website is further configured for entry of a conditional pledge by the voting member for storage in the database. The method further includes receiving the identifying and contact information, receiving the conditional pledge from voting members on the website, and storing the information and the conditional pledges in the database. A calculation is performed to determine whether a first pledge condition has been reached. When the first pledge condition has been reached, the voting members with conditional pledges stored in the data base are informed that the first pledge condition has been reached and to vote according to their pledge.

### BRIEF DESCRIPTION OF THE DRAWINGS

The foregoing will be apparent from the following detailed description, as illustrated in the accompanying drawings, in which:

FIG. 1, including FIGS. 1a, 1b, and 1c is a flow chart showing one embodiment of the process steps of the present patent application; and

FIG. 2 is a block diagram showing the devices used in implementing the present patent application.

### DETAILED DESCRIPTION

The present patent application provides an automatic system for organizing a sufficient segment of an electorate to remove incumbents who are unresponsive to their constituents. The system does so by aggregating and tabulating conditional voter pledges. In one embodiment, when the system has tabulated an effective number of pledges that exceeds the incumbent's anticipated margin of victory in the next election, the condition is satisfied, the pledge is “triggered,” and pledged voters are automatically notified to vote according to their pledges. If they do so, the shift in the vote so produced is greater than the incumbent's anticipated margin of victory.

In one embodiment, the pledge condition trigger is prevented if the incumbent has taken a previously identified action desired by the constituents. In this embodiment, if the system is close to tabulating an effective number of pledges that exceeds the incumbent's anticipated margin of victory in the next election the incumbent must choose to take the action desired by that pledged segment of constituents or take a heavy risk of being ejected from office in the next election. In one embodiment, the pledge also includes a commitment to vote for the incumbent if the incumbent has taken the desired action.

The method provided in this patent application is particularly useful during a period in which elected representatives, individually and collectively, place themselves in violation of the will of the people, and ordinary voting is rendered ineffective.

By effectively organizing voters to achieve results on issues rather than to support candidates or parties, the method provided in this patent application empowers ordinary citizens to counter the vast influence of money in elections and reclaim democratic control of government. It empowers ordinary citizens to toss out the money-influenced incumbents or to force even the most money-influenced incumbents to take effective action to overturn the Supreme Court decisions as a condition of retaining office. Thus, the method allows ordinary citizens not just to counter the vast influence granted by the Supreme Court Five to the 1%, it allows ordinary citizens to overcome and overturn the vast influence of money in elections. At the same time, the method requires Congress to use constitutionally provided checks and balances to halt encroachment by the Supreme Court on its constitutional power to oversee the manner of elections and confine the Supreme Court to its legitimate judicial powers.

In one embodiment, the system provides a program running on a computer that enhances the well-established power of traditional single-issue strategic voting. The computer driven system is herein called “swing-issue voting.” In the examples provided in this patent application, removing money from elections is used as the illustrative policy goal. The swing-issue voting scheme can also be used to implement other previously agreed upon policy goals.

In one embodiment, the program running on a server allows voters to register their pledges on a website, checks data for authenticity, tallies the pledges, compares the tally with an expected margin of victory in a forthcoming election, verifies the data, determines when a sufficient number of pledges have been registered to overcome that expected margin, and informs the pledged voters to vote according to their pledge if that number has been reached.

In one embodiment the program automatically informs the incumbent of progress toward gathering pledges, thereby forcing the incumbent to take a previously identified action against money in elections or face a high probability of being voted out of office if the incumbent fails to take the effective action before the effective pledged total reaches the incumbent's expected margin of victory. Thus, the program both provides a way to force the incumbent to take action and provides a way to remove the incumbent if the incumbent fails to do so. Advantageously, the program requires action by an incumbent before the election, not mere promises of eventual action. In another embodiment, a date may be designated by which the incumbent must act. By aggregating enough voter pledges to reach the anticipated margin of victory for the incumbent the program also communicates a high probability of removal of the incumbent if the incumbent fails to take the required action.

Examples of the power of the traditional form of single-issue strategic voting stand out in United States history. Traditional single-issue strategic voting has been a powerful tool in the first-past-the-post single member district voting system that is used throughout the United States.

In one example, the power of single-issue strategic voting was illustrated by an extreme case of its successful use about 90 years ago. The issue at that time was the prohibition of alcohol. Using single-issue strategic voting, prohibitionists forced a constitutional amendment to be adopted by ⅔ vote of both houses of congress and ¾ of the state legislatures—even though a majority of the voting population were drinkers, as were a bigger majority of the members of Congress. The goodness or badness of prohibition is irrelevant to a discussion of the strategy. The fact that the actual level of support for prohibition enjoyed among the population and among congressmen and legislators was sharply below a majority demonstrates the extreme power of the strategy.

Illustrating that power, only the support of a minority of voters was available, yet prohibitionists succeeded in getting this constitutional amendment, and implementing legislation of their own devising, passed. A member of Congress voted for prohibition not because he or she supported prohibition but because if the member failed to do so, the member knew that he or she would be voted out of office in the next election because of the exceptional power single-issue strategic voting provided to its users in a first-past-the-post electoral system.

Of course single-issue strategic voting is even more likely to be successful in a less extreme situation where not just 10-20% of the voters but a considerable majority of Americans are supporters. Such a majority is consistently polled as wishing to overturn the Citizens United line of cases and get money out of elections.

Thus, resort to the far more powerful electoral technique used by the advocates for prohibition is now mandated. The swing-issue voting system provides an efficient tool that allows voters to both self-organize and require candidate action on behalf of issues and concrete policy solutions.

This patent application provides embodiments updating the electoral groundwork laid by the advocates for prohibition, this time to accomplish what a majority of Americans strongly support—taking electoral office away from those with the backing of monied interests and putting that power in the hands of the people. The updated system, herein called “swing-issue voting,” combines aspects of single-issue strategic voting with aspects of digital technology.

The update provided in the present patent application includes computer and internet tools and methods that vastly improve single-issue strategic voting. In one embodiment, the update allows ordinary voters to oppose the schemes implemented by the US Supreme Court to flood elections with money that vastly increased the political power of the highest monied fraction of the one percent. In this embodiment, the update allows large numbers of people to register, join forces, mutually recognize their potential voting power, collaborate with and network with each other, and take effective electoral action to oppose the systemic corruption that money system established, and confirm that they have done so.

The update allows these large numbers of ordinary people to take this effective action while remaining independent of control or regulation by any established politician or monied interest, without any elaborate and expensive organizational activity, without any established leadership, and using a system that is transparent in its operation.

The update provides a majority of Americans with simply operated tools for direct democratic control over government, tools that require legislators to be responsive to the majority of people, and tools that counter the subservience of politicians to the wishes of the 1%.

In one embodiment, the tools and methods of the present patent application organize these large numbers of people into a powerful voting bloc against incumbents who refuse to take identified effective action to remove money from elections. The tools and methods of the present application can also be used to accomplish other policy objectives once money is removed as the paramount factor in representatives' policy action decisions.

In one embodiment, the vast amounts of money now used to purchase both elections for incumbents and desired policies for their contributors is countered by technology-based organized voting against an incumbent who fails to take a specific designated policy action. In one embodiment, this organized voting is accomplished in the swing-issue voting scheme using a website on the internet to gather pledges to vote for the opposing candidate most likely to unseat the incumbent, regardless of that opposing candidate's views on money in elections and other matters. In another embodiment voters using the website may select among several pledge choices, including at least one that weighs heavily against the incumbent.

One embodiment of swing-issue voting attempts to force the incumbent to take previously identified effective action against money in politics before the election. This embodiment relies on gathering a sufficient number of pledges so as to achieve a high level of probability that the incumbent will be unseated if the pledgers vote as they pledged. The incumbent then has the choice to accept the will of the people to take the desired effective action before the election so as to avoid the automatic call to honor the pledges and defeat the incumbent.

Absent such effective action against money in politics by the incumbent, if the incumbent is defeated in the election, the swing-issue voting scheme is likely to be even more effective at pressuring an opposing candidate who takes office based on the demonstrated power of the participants in the single issue voting system.

One example of effective action a senator or member of Congress may take at the federal level is to add his or her name as a sponsor of legislation that strips the US Supreme Court of appellate jurisdiction over cases that involve first amendment issues related to election financing. Other effective actions can be required, such as, for committee chairs and leadership members, taking action to move the jurisdiction-stripping legislation forward to a vote in the House or in the Senate.

Authority to regulate and make exceptions to the appellate jurisdiction of the Supreme Court was expressly provided in Article 3 section 2 of the US Constitution by the founding fathers who recognized that effective checks and balances were needed against each of the three branches of government, including the Supreme Court, to prevent tyranny. The founders were especially concerned about the unelected Supreme Court. Regulating jurisdiction of the federal courts has been a standard part of legislation passed by Congress ever since the very first congress in 1789 that enacted legislation setting court jurisdiction on a long list of appellate matters while making exception to court jurisdiction over criminal appeals. One other historic example was Reconstruction era legislation in which Congress made an exception to the Supreme Court's jurisdiction in order to preserve military government as a necessary tool of Reconstruction. The Supreme Court unanimously accepted this legislation as a valid constitutional act stripping the Court's jurisdiction over the habeas corpus appeal dismissed in Ex Parte McCardle (Congress' “power under the Constitution . . . to make exceptions to the appellate jurisdiction of this court is given by express words” of Article III, Sec. 2).

The present patent application provides a way for millions of ordinary citizens to organize themselves and to engage in broadly supported collective action to force even already corrupted members of Congress to honor the consent of the governed and use their existing constitutional authority in order to check and balance the US Supreme Court.

Under the methods of the present patent application, money in elections is effectively countered by a low budget technology-based swing-issue voting scheme. By gathering and aggregating their pledges on a secure website platform, voters are effectively organized to require incumbents in House and Senate to take a specifically designated policy action to abolish the influence of money in elections if the incumbents wish to avoid being swing-issue voted out of office.

### The Voter's Pledge Web Page

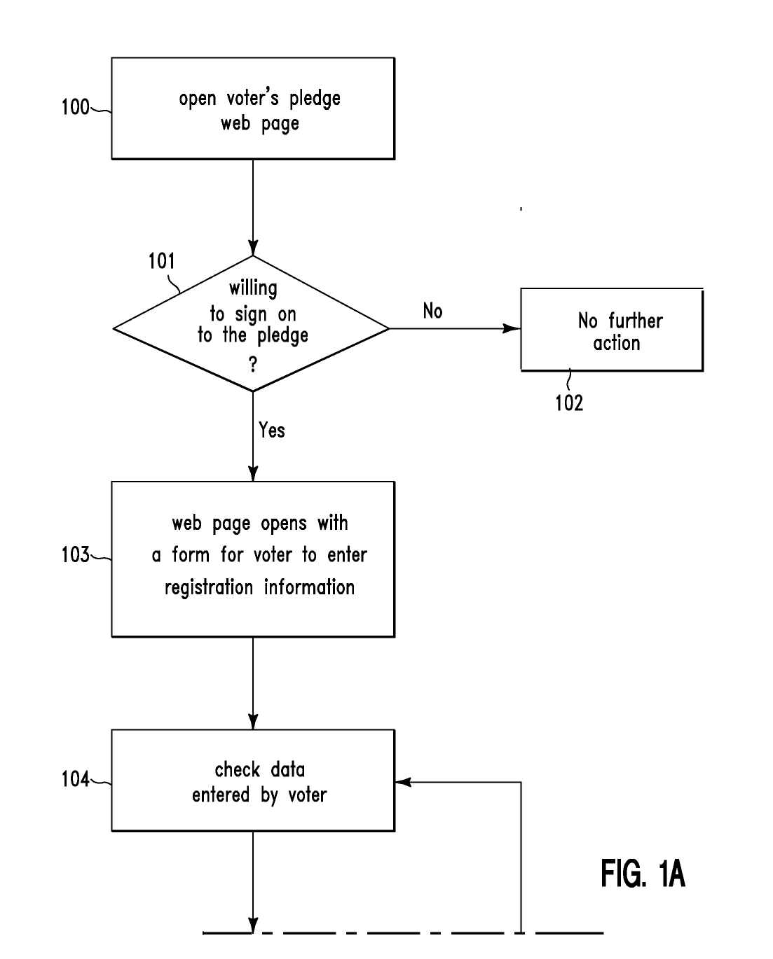

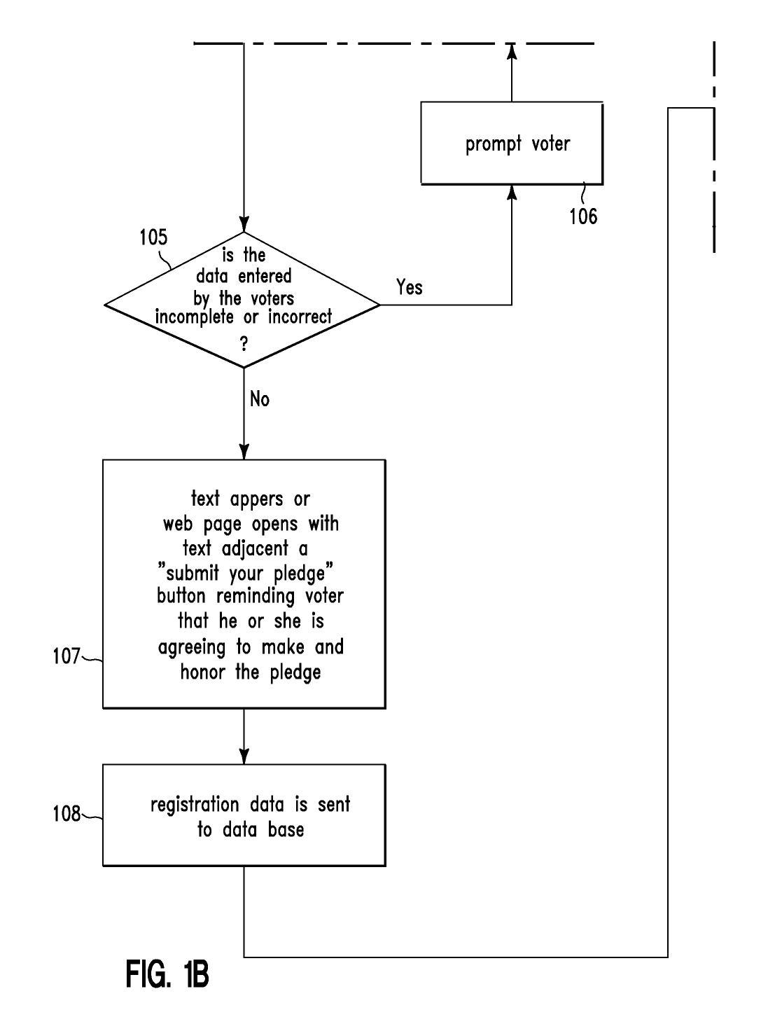

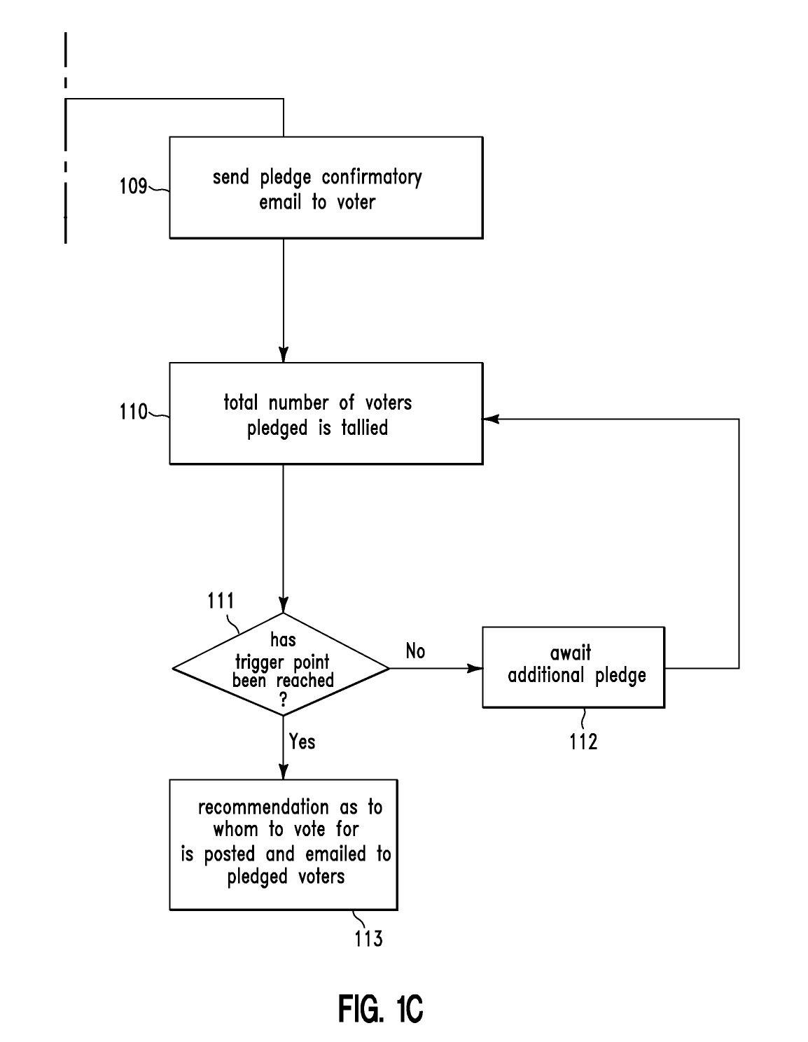

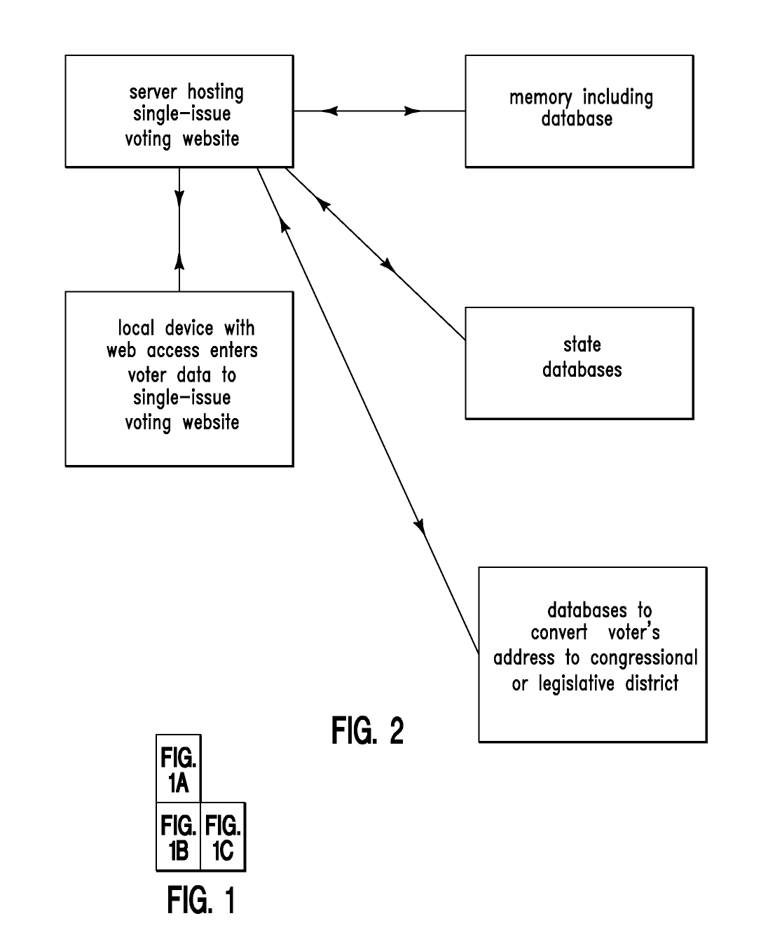

One embodiment of the system of the present patent application is illustrated in the flow chart of FIG. 1. In this embodiment, interested voters open the Voter's Pledge web page, as shown in box 100. In this embodiment, the Voter's Pledge web page is secured in a format, such as “https,” to protect user data privacy while entering their data. Other standard security methods can also be used to filter data for authenticity. In one embodiment, the Voter's Pledge web page includes a pledge that voters may sign electronically.

### The Voter Pledge

### A. Two-Way Pledge

In one embodiment of an election in which an incumbent is running for reelection, the voter pledge states:

“I am eligible to vote in the next election, and for that election, I Pledge that I (a) will not vote for the incumbent if the incumbent refuses to sponsor or endorse the Legislation that will remove money from politics, or refuses to take such other effective action as needed to bring such Legislation to a vote and (b) will vote for the incumbent if the incumbent sponsors or endorses the Legislation that will remove money from politics, and takes such other effective action as needed to bring such Legislation to a successful vote. This pledge becomes effective only when a sufficient number of eligible voters have signed on that exceeds the anticipated margin of victory in the forthcoming election.

“If a sufficient number of eligible voters sign on so this pledge becomes effective I request and agree that this website will automatically timely inform me that my pledge has become effective. I commit to honor that pledge when I am so informed by voting as pledged in the next election.

“I also request that this website let me know about the effective ways to vote to defeat the incumbent so as to apply the most pressure on the incumbent or on his or her successor for enacting the Legislation to remove money from politics. I understand that among these effective ways to vote include voting for the opposition candidate deemed to be most likely to unseat the incumbent, regardless of that opposition candidate's views on money in elections and other issues.”

### B. Swing Voter Determination

In another embodiment, preliminary questions are posed to the voter. Based on the answers, pledge choices are provided from which the voter may make a selection. A program running on the processor in the server running the web site determines the effect of the pledge selection chosen by each individual voter on the outcome of the election. In this embodiment, text is provided on the web site such as:

“The final steps of the registration process are (a) to answer the following preliminary polling-type question and (2) to make your pledge choice.

“Your answer to the preliminary question and your pledge choice will be used by the computer program running this website, along with the answers and choices of other pledged voters, to determine whether enough voting power has been pledged to exceed the anticipated margin of victory in the forthcoming election. When that happens, the server will automatically notify you, and all others who have pledged, that your pledges have become effective and that you are expected to honor them. At that moment, collectively we will be applying maximum pressure for enacting legislation to end money in politics prior to the next election. Here is the preliminary question:

“If the election were held today, aside from any effect of your pledge, which of the following would best describe your voting intentions based on past experience and present inclination:
1) I would vote for the incumbent [name] [party ].
2) I would vote for the candidate nominated by the [name party of the closest opponent]
3) I would not vote, spoil my vote, or vote for a third party”

Each pledger will be asked to review the pledge. In one embodiment, the text of the Pledge provides to the effect that, on the sole condition that enough persons pledge to determine the outcome of the election, the pledger will cast a vote for the incumbent only if the incumbent takes the previously determined action to take money out of elections but otherwise will not vote for the incumbent. Each pledger will be asked to click on the “Submit Your Pledge” button signifying agreement.

A message will then be provided thanking each pledger for participating in this citizen-based direct democracy movement to restore democratic policy making In one embodiment, the message will also let the voter know that an email will be sent to the incumbent stating that another voter has pledged that he or she will vote for the incumbent if and only if the incumbent takes the specified policy action to end money in elections. Special text will be added to this common message for pledgers depending upon their selections to the preliminary question herein above.
1. Pledgers who clicked the option 1) “I would vote for the incumbent, [name][party]” will receive a message with the following additional text:
   “Congratulations. You have pledged not to vote for an incumbent who you otherwise would have voted for unless the incumbent takes immediate action, prior to the election, to earn your vote. The communication of this fact to the incumbent will contribute to achieving the policy goal of ending money in elections by informing the incumbent that one supporter's vote will be lost if the incumbent does not take the designated effective action in support of that policy goal prior to the next election.
   “We now give you the opportunity to double your voting power by also pledging that if the incumbent does not take the desired policy action you will vote for the incumbent's closest opponent, whoever that opponent may be, provided enough other pledges are collected to assure defeating the incumbent if all pledgers cast their vote as promised.
   “Any alternative voting strategy, other than voting for the leading opponent, will have only half the impact on reaching the policy goal. By threatening not just to subtract one vote from the incumbent but also to add that vote to the leading opposition candidate your vote will acquire the effect of two votes in reducing the margin of the incumbent's lead over the opposition. Therefore if you pledge by clicking the following box you will double the power of your message to the incumbent by pledging to join other pledgers in defeating the incumbent by means of voting for the opposition candidate on the condition that there are enough pledged votes to defeat the incumbent.”

Button—“I want to double my voting power. I pledge to vote for the leading opposition candidate if the incumbent fails to take the previously designated effective action to remove money from elections.”
2. Pledgers who clicked the option 2) “I would vote for the candidate nominated by the [name] [party of the closest opponent]” will receive a message on the website with the following text:
   “Congratulations. You have pledged to vote for an incumbent who you otherwise would not have voted for provided the incumbent takes immediate action, prior to the election, to earn your vote. The communication of this fact to the incumbent will contribute to achieving the policy goal of ending money in elections by informing the incumbent that both a new vote will be gained by the incumbent and a vote will be lost to the incumbent's closest opponent depending on whether the incumbent supports the policy goal of ending money in elections and is willing to take the previously designated effective action, as requested, prior to the election.”
3. Pledgers who clicked the option 3) “I would not vote, spoil my vote, or vote for a third party” will receive a message on the website with the following text:
   “Congratulations. You have pledged to vote for an incumbent who you otherwise would not have voted for, provided the incumbent acts now to earn your vote. The communication of this fact to the incumbent will contribute to achieving the policy goal of ending money in elections by informing the incumbent that one new potential supporter's vote may be won only if the incumbent will support that policy goal of ending money in elections, as requested, prior to the next election.
   “This can be a powerful use of your vote to change policy now, provided enough people join you in pledging to support this change to make it effective.
   “We now give you the opportunity to double your voting power by also pledging to vote for the incumbent's closest opponent, whoever that opponent may be, if the incumbent refuses to act as requested to achieve ending money in elections. This second pledge is also conditioned on enough other pledges being collected to assure defeating the incumbent if all pledgers cast their vote as promised. If enough pledges are not collected this pledge is not triggered.
   “Any voting strategy other than voting for the leading opponent will have only half the impact on reaching the policy goal. By both subtracting one potential vote from the incumbent and adding it to the leading opposition candidate your vote has the effect of two votes in reducing the margin of the incumbent's lead over the opposition. This will double the incentive for the incumbent to take the designated action to end money in elections. If you click the following box you will double the influence of your message on the incumbent by pledging to join other pledgers in either re-electing or defeating the incumbent by means of voting for either the incumbent or the opposition candidate (on the sole condition that there are enough pledged votes to defeat the incumbent) depending on incumbents' support for [describe goal]prior to the next election.
   “We understand this requires prioritizing this issue. It requires ignoring the possible effect on other issues that the respective candidates or parties might have. But the new candidate's views on anything at all are irrelevant, and are normally espoused to get votes. The new incumbent can be expected to do what is necessary to keep the office, or will be even more easily ejected from office in the same manner by your vote and that of other pledgers in the next election for the same reasons if support for ending money in elections is denied to pledgers most responsible for the new incumbents' victory.”

Button: “I want to double my voting power. I pledge to vote for the leading opposition candidate if the incumbent fails to take the previously designated action to remove money from elections.”

### C. Negative Pledge

In another embodiment, the text of the Pledge provides to the effect that, on the sole condition that enough persons pledge to determine the outcome of the election, the pledger will not cast a vote for the incumbent if the incumbent refuses to sponsor or endorse the legislation that will remove money from politics, as described in this website, or refuses to take such other effective action as needed to bring such legislation to a vote. Each pledger will be asked to click on the “Submit Your Pledge” button signifying agreement. This negative formulation of the pledge allows voters who would not necessarily ever agree to vote for the incumbent to participate in the pledge process.

In one embodiment, subsequent to answering the preliminary question in part B herein above, the pledger would be the offered the following options:

Pledgers who clicked the option (1) “I would vote for the incumbent, [name] [party]” will receive a message with the additional text as described herein above to the effect of their pledge by also pledging to vote for the closest opponent.

Pledgers who clicked the option (2) “I would vote for the candidate nominated by the [name] [party of the closest opponent]” will receive a message as described herein above to double the effect of their pledge by also pledging to vote for the incumbent if the incumbent takes the previously described effective action to end money in elections.

Pledgers who clicked the option 3) “I would not vote, spoil my vote, or vote for a third party” will receive two messages and two buttons that they may press either individually or in combination to increase the effect of their pledge: (a) by pledging to vote for the incumbent if the incumbent takes the previously described effective action to end money in elections and/or (b) by pledging to vote for the closest opponent if the incumbent refuses to take the previously described effective action to end money in elections.

In one embodiment, the program on the server assigns different point values depending on the preliminary question and the pledge buttons selected. For example, a voter who would have ordinarily voted for the incumbent but is pledging to vote for the closest opponent if the incumbent fails to take the effective action is assigned two points. A voter who would have ordinarily voted for the closest opponent but is pledging to vote for the incumbent if the incumbent takes the effective action is also assigned two points.

A voter who would have ordinarily voted for the incumbent but is only willing to pledge to not vote for the incumbent (such as by not voting at all, voting for a third party, spoiling the ballot, etc.) if the incumbent fails to take the effective action is assigned one point. A voter who would have ordinarily voted for the closest opponent and is only willing to pledge to not vote for the incumbent if the incumbent refuses to take the effective action is not actually changing her vote and so is assigned zero points. A voter who would have ordinarily not voted or would have voted for a third party and is only willing to pledge to not vote for the incumbent if the incumbent refuses to take the effective action is still not actually changing her vote and so is also assigned zero points. A voter who would have ordinarily not voted or would have voted for a third party and is willing to pledge to vote for the incumbent if the incumbent takes the effective action is assigned one point. A voter who would have ordinarily not voted or would have voted for a third party and is willing to pledge to vote for the closest opponent if the incumbent refuses to take the effective action is also assigned one point. A voter who would have ordinarily not voted or would have voted for a third party and both is willing to pledge to vote for the incumbent if the incumbent takes the effective action and is willing to pledge to vote for the closest opponent if the incumbent refuses to take the effective action is also assigned one point.

In one embodiment, the processor on the server tallies the points for all pledgers and compares that number with the number of votes needed to overcome the lead by the incumbent. When the number of points exceeds the number of votes needed then the pledged voters have the power to remove the incumbent from office. In an alternative embodiment, the processor on the server tallies the points for all pledgers and compares that number with the number of votes needed to overcome the lead by the opponent of the incumbent. When the number of points exceeds the number of votes needed then the pledged voters have the power to return the incumbent to office.

In one embodiment, voters read the pledge and consider whether to sign on, as shown in query box 101. If the voter decides not to take the pledge, no further action is taken and no record is saved by the system with respect to this voter, as shown in box 102.

In this embodiment, if the voter decides to take the pledge by checking the box and pressing the “I agree to the pledge” button, the system provides a web page with a form in which the voter provides registration information, as shown in box 103. In one embodiment, the registration information includes first name, last name, home street address, town, state, zip code, email address, and phone number. The registration portal includes blocks for entering this identifying information and contact information.

Other information may also be requested, such as a password to enable the user to later re-access the web page to make changes and/or to confirm that the voter cast his or her vote as pledged, as further described herein below.

In one embodiment, the server is linked to a data base that determines electoral race information, such as the congressional district and the state legislative district, from the home address.

In one embodiment, based on the state or local address given, the server automatically queries a publically available online database for that state or local government to determine what elections are forthcoming for that voter and provides a list from which the voter can select, such as President, US Senator, member of Congress, Governor, state legislature, town select board, school board, etc. A database containing this information may be available from the Secretary of State for the particular state.

In another embodiment, the user enters information regarding the election of interest, such as the particular office or the name of the incumbent.

As some states have only one congressional district the system may automatically determine the congressional district from the name of the state. If the name of the state is not sufficient to determine the congressional district, and if a data base that determines congressional district from home address is not available, the system may provide input boxes on a web page seeking additional information. For example, in states having more than one congressional district entering the home 9-digit zip code or the name of incumbent may be used to determine the electoral district of the voter. A hypertext link on the form, such as http://tools.usps.com/go/ZipLookupAction!input.action can be used to help the voter find the nine-digit zip code. The name of the incumbent may be obtained by entering the zip code at a site such as http://www.house.gov/representatives/find/.

In an embodiment for elections, such as for a state legislature, corresponding entries such as the home address, 9-digit zip code, name of incumbent, or the official legislative district designation can be used for the purpose of determining the voter's legislative electoral district. From the electoral district selected the system automatically obtains the names of the incumbent and the opposing candidates on the ballot from the state or local government official website.

In another embodiment, for federal and statewide elections, the system provides a web page in which the voter clicks to select the specific race, such as US president, US senator, governor, lt. governor, treasurer, secretary of state, auditor, etc. From the state and the race selected the system automatically obtains the names of the incumbent and the opposing candidates on the ballot from the state or local government official website, as shown in the block diagram in FIG. 2.

In one embodiment, as the voter selects or enters data in each input cell, the server runs a program to filter and check the data for security threats, completeness, appropriateness of the number and types of alphanumeric characters entered and additional cell-specific formatting parameters, as shown in box 104.

In elections in which no incumbent is running, the system can be used to organize for or against one of the candidates. In one embodiment the system determines the names of the opposing candidates on the ballet and searches online for relevant positions taken in connection with those names. In one embodiment a recommendation based on a political audit of those positions is posted.

The system may be used in general elections, primary elections, and caucus elections in single member districts in which the candidate with the highest number of votes is declared the winner. Some features of the system may be used in multiple member districts.

If the program running on the server detects that an entry is incomplete or incorrect, as shown in box 105, the server prompts the voter and displays text on the web page or in a pop-up box to correct the entry, as shown in query box 106. For example, in one embodiment, the server checks that names include appropriate alphabetic letters and that phone numbers and zip codes include numbers. In another embodiment the server verifies against available online public information, such as an online voter registration roll or a phone book. Encryption may be used to enhance security. In one embodiment the server runs a program, such as one that requires the user to read and copy a text, such as twisted alphanumeric characters, to prevent robotic logging on to the system.

In one embodiment, once the server detects that the registration information passes its completeness and correctness program, the server provides text adjacent to or as a pop-up at the “Submit Your Pledge” button reminding the voter that when the voter clicks on the button, he or she is agreeing to make and honor the Voter Pledge, as shown in box 107 for the election selected. A preliminary question may be included, as described herein above. The pledge may be followed up with additional optional pledge requests, as also described herein above.

When the voter completes all data entry cells correctly and clicks on the “Submit Your Pledge” button, the data entered is immediately encrypted to provide a high level of data security while the data is being sent to and stored in the database in the memory connected to the server running the website, as shown in box 108.

### The Database

In one embodiment the database includes the fields for the registration information provided by each voter who makes the pledge for each a congressional, statewide, or legislative election plus additional information, such as an ID number assigned by the system and a time stamp indicating exactly when the data was entered into the database.

In one embodiment the checking performed by the processor before and/or after information is stored in the database includes checking newly entered voter information against existing database entries to ensure that duplicate entries are prevented. If the new voter information appears to be a duplicate, or if there is some other problem with registration that prevents successful entry of data, the server provides the voter with a message describing the problem and advice on how to proceed. The message may be sent to the voter using a pop up window on the web site while the voter is still connected to the web page, by an automatic communications method, such as email, text, or social media. In one embodiment, the message may direct the voter to send an email to a specified email address to obtain assistance in resolving the issue.

Data records are stored in a highly secure, encrypted format to provide a high level of data security while residing in the database.

### Pledge Confirmation Page

In one embodiment, if registration information was submitted without errors or security threats and no duplicate was found in the database, the new voter information is added to the database and the server immediately sends a pledge confirmation email to the voter to inform the voter that his or her pledge was successful, as shown in box 109.

In one embodiment, the processor determines the number of voters pledged and/or the sum of the point scores for all pledged voters listed in the database, as shown in box 110. In one embodiment, with each voter pledging, the processor adds the point score of the newly pledged voter to the number previously stored and assigns that number as the newest voter pledging's ID. That ID number and that total point score for the voters so far pledging is also provided to the voter in the voter's confirmation message.

In one embodiment, a voter can later sign back into the website and withdraw her pledge. For example, a check box can be provided next to text stating, “I wish to withdraw my pledge.” Such a mechanism is likely to improve the quality and effectiveness of the pledged voter database. The ability to withdraw also may allow more people to pledge knowing they can later withdraw the pledge if they later change their minds. The effectiveness of an incumbent politician's actions, promises, and campaign strategy and the firmness of the public opposition to money-in-politics may be gauged by the number of pledges and the level of pledge withdrawal.

In one embodiment, the server may provide the voter with a web page that includes a second chance at persuasion for those indicating a desire to withdraw the pledge. For example, in this embodiment, the server may provide a dialogue box on the web site that provides text in which the voter checking the box indicating a desire to withdraw the pledge may consider current information and the pros and cons of withdrawing the pledge before the voter confirms the request.

### Mobile Device:

Alternatively an app for a mobile device may be used in which the app includes a program and a registration portal. In this embodiment the mobile processor may run the app and automatically wirelessly communicate information entered on the mobile device for storing in the data base.

### Pledge Statistics Menu Web Page

In one embodiment, a Pledge Statistics Menu web page is provided that provides an interface that allows the database for each voting district to be queried in real time for statistics related to pledges, including the number of pledges, the total number of points, and the number of votes previous elections or polling data shows separating the incumbent from the closest challenger. Other data may be obtained for informational and diagnostic purposes through queries of the data base.

The queries also allow voters to perform real-time checks on the status of overall pledges or pledges for a particular voting district. Thus, a voter in a congressional district will be able to make such a query to determine the level of pledges and compare that level with the remaining margin of victory for or against the incumbent's reelection.

In one embodiment, a program running predetermined queries is used to automatically audit the data. In one embodiment, the server downloads state voter registration data that may be available on the website of the Secretary of State. The server compares each name entered by pledgers with names on that voter registration data. In one embodiment, if the name of the pledger is not found, the server sends the pledger a notice to register to vote. If the name continues not to be found on the official voter registration list, the name is removed from the data base.

In one embodiment, if the name entered by a pledger is found in the official voter registration list, the server automatically dials the phone number of the registered voter, as listed on the official voter registration list or as listed in another online source, such as a phone book. When the phone is answered the server automatically asks the voter a question, such as, “did you register on the swing issue voting system?” If the voter responds affirmatively, the server retains the registration in the data base and counts this as a positive for the audit. If the voter responds negatively, the server removes that registration from the data base. In another embodiment, only a statistically valid sample of the registered voters corresponding to pledgers is automatically called. In another embodiment, if the official voter registration list includes email addresses, in one embodiment, this audit is accomplished by the server sending an email to the email address of the pledger as provided on the official voter registration list.

### Trigger Point

The trigger point is reached when the number of pledges tabulated, as described herein above, exceeds a measure of the anticipated margin of victory for the incumbent in the current election. The anticipated margin of victory for the incumbent in the current election can be approximated as the actual margin of victory for the incumbent in the previous election. Alternatively the anticipated margin of victory for the incumbent in the current election can be set by a current opinion poll showing voter intentions and indicating the likely difference in support between the incumbent and leading challenger. Pledgers will be asked at any time prior to the trigger point to respond to any election polling question that they are conditionally pledged and intend to vote according to the pledge. When, through the process described in the present patent application, the vote will be shifted by an amount equal to or greater than the anticipated margin of victory the incumbent is likely to have little of no assurance that he or she will win the election and may feel motivated to take corresponding action.

If no incumbent is in the race, then the polling data between the top two candidates for the post may be used, as shown in box 111, and as further described in the Voting Guide Web page section herein below.

In one embodiment, until the trigger point is reached the server sends no message to pledgers requesting that they honor their pledges. Thus, if the trigger point is not reached before the election, pledges submitted by pledged voters need not be honored when they arrive at the voting booth, as shown in box 112. In this embodiment, if the trigger point is reached before the election, the server sends a message informing pledgers to honor their pledges when they vote.

In one embodiment, the number of pledges or the total number of points is automatically compared with the anticipated margin of victory by the computer. If the anticipated margin of victory is determined by current polling data, which may vary with time, the trigger point is also a variable. In one embodiment the computer includes a program to search online for polling data. Other methods of estimating the current margin of victory may be used to determine when the trigger point has been reached.

In one embodiment, the server may be programmed so that if the number of pledges becomes substantially larger than the margin of victory, pledged voters are encouraged to vote against the top two candidates and for someone lower down in the polling, such as a third party candidate.

### Voting Guide Web Page

The voting guide web page includes a table that displays real-time updates of the status of pledges for each voting district. In one embodiment, the table displays the ratio of tallied effective pledges or tallied points divided by the best estimate of the margin of victory for each voting district, such as provided by polling data. In one embodiment, the ratio is displayed as a percentage, and when the percentage exceeds 100%, the trigger point is reached, and the votes of the people who pledged are expected to be sufficient to swing the election to the candidate listed in the table if all those who pledged vote as pledged.

In one embodiment, when enough pledges have been made for a particular voting district to swing the election based on the most recent election results or most meaningful polling data readily available, an advisory email is automatically generated by the server and sent to pledged voters saying that the pledge has been triggered and including a reminder with information about the choice of opposition votes including the most effective opposition vote to defeat the incumbent, as shown in box 113. In one embodiment, the advisory is also placed in a table on the Voting Guide web page. The email may also remind voters to check the Voting Guide web page for other information and recommendations and to inform them to actually vote as they pledged so the system functions at its optimal efficiency.

### Audits

In one embodiment, after the server conducts its automatic audit of registration data, further automatic auditing is performed to ensure the integrity of the data. For example, pledgers may automatically be called by the server at periodic intervals to verify that they intend to honor their pledges. In addition, at least one political auditor is provided to monitor the performance of the incumbent to determine whether he or she took the designated policy action to end money in elections and to report findings.

While several embodiments, together with modifications thereof, have been described in detail herein and illustrated in the accompanying drawings, it will be evident that various further modifications are possible without departing from the scope of the invention as defined in the appended claims. Nothing in the above specification is intended to limit the invention more narrowly than the appended claims. The examples given are intended only to be illustrative rather than exclusive.

What is claimed is:

1. A method of organizing voting members of a district to shift margin of victory between candidates in an election, comprising:
a. providing a server for running a program linked to a database, wherein said program provides a website, wherein said website is configured for entry of voting member identifying information and voting member contact information for storage in said database, wherein said website is further configured for entry of a conditional pledge by the voting member for storage in said database;
b. receiving said identifying and contact information, and receiving said conditional pledge from voting members on said website and storing said information and said conditional pledges in said database;
c. calculating to determine whether a first pledge condition has been reached; and
d. when said first pledge condition has been reached, informing the voting members with conditional pledges stored in the data base that said first pledge condition has been reached and to vote according to their pledge.

2. A method as recited in claim 1, wherein said first pledge condition is related to an anticipated margin between the candidates in the absence of the present method.

3. A method as recited in claim 1, wherein said first pledge condition has been reached if said calculating determines a calculated number that equals or exceeds the anticipated margin in the next election in the absence of the present method.

4. A method as recited in claim 3, wherein said anticipated margin is based on one from the group consisting of polling and reviewing election history.

5. A method as recited in claim 1, wherein said calculated number equals the number of voting members with conditional pledges in said database.

6. A method as recited in claim 1, wherein said website is further configured for entry of information about anticipated voting by the voting member in the absence of the conditional pledge, wherein said calculated number is based on said information about anticipated voting in the absence of the conditional pledge and the terms of the conditional pledge.

7. A method as recited in claim 6, wherein said calculated number equals the number of voting members with information about anticipated voting and conditional pledges indicating a one point shift in the margin between candidates plus two times the number of voting members with information about anticipated voting and conditional pledges indicating a two point shift in the margin between candidates.

8. A method as recited in claim 1, further comprising providing a program for a mobile device, wherein said program includes collecting said voting member identifying information, said voting member contact information, and said conditional pledge, wherein under said program said mobile device wirelessly communicates said collected information and said pledge from said mobile device for storing in said database.

9. A method as recited in claim 8, wherein said program further includes collecting information about anticipated voting.

10. A method as recited in claim 1, wherein said website includes blocks for entering said identifying information and said contact information, and a tick block for making said conditional pledge.

11. A method as recited in claim 1, wherein said providing a database includes providing a secure database.

12. A method as recited in claim 1, wherein said program further comprises providing a second pledge condition, wherein said second pledge condition is satisfied if a candidate in the election has not taken a pre-specified action, wherein said automatically informing the pledged voters is performed when both said first pledge condition and said second pledge condition have been satisfied.

13. A method as recited in claim 10, wherein the candidate who did not take the pre-specified action is an incumbent, further comprising notifying the incumbent that the incumbent will be removed from office unless the incumbent takes the pre-specified action.

14. A method as recited in claim 1, further comprising verifying that the voting member is registered to vote in the district.

15. A method as recited in claim 1, wherein said verifying that the voter is registered in the district includes automatically comparing the identifying information with information in the election district voting list.

16. A method as recited in claim 15, further comprising drawing identifying information from the election district voting list.

17. A method as recited in claim 1, further comprising connecting to a second database, wherein voting member information is stored on said second data base, retrieving information from said second data base, and the voting member selecting information about the voting member from the information in the second data base.

18. A method as recited in claim 17, wherein said second data base is an official data base.

19. A method as recited in claim 1, wherein said program provides an additional preliminary question on said website, wherein said program provides pledge choices that depend on an answer to said preliminary question.
